(19) United States
(12) Patent Application Publication
(10) Pub. No.: US 2025/0298371 A1
(43) Pub. Date: Sep. 25, 2025

(54) SPATIAL LIGHT MODULATOR AND HOLOGRAPHIC 3D DISPLAY DEVICE

(71) Applicant: TOHOKU UNIVERSITY, Miyagi (JP)

(72) Inventors: Hideo FUJIKAKE, Miyagi (JP); Hiroto TOCHIGI, Miyagi (JP); Masakazu NAKATANI, Miyagi (JP); Ken-ichi AOSHIMA, Tokyo (JP); Mayumi KAWANA, Tokyo (JP); Yuta YAMAGUCHI, Tokyo (JP); Kenji MACHIDA, Tokyo (JP); Nobuhiko FUNABASHI, Tokyo (JP)

(73) Assignee: TOHOKU UNIVERSITY, Miyagi (JP)

(21) Appl. No.: 19/087,566

(22) Filed: Mar. 23, 2025

(30) Foreign Application Priority Data
Mar. 25, 2024 (JP) 2024-047720

(51) Int. Cl. G03H 1/00; G02F 1/1337; G02F 1/1343; G03H 1/02

(52) U.S. Cl. CPC G03H 1/0005; G02F 1/1337; G02F 1/134336; G03H 1/02; G03H 2001/0088; G03H 2001/0224

(57) ABSTRACT

To enable independent driving of pixels with a fine pixel pitch, a spatial light modulator includes: a first substrate; a second substrate facing the first substrate; and a liquid crystal layer located between the first substrate and the second substrate, wherein the first substrate has, on a substrate surface thereof, driving electrodes located on both sides of each of pixels arranged in a first direction among pixels arranged in a matrix and ground electrodes located between rows of driving electrodes arranged in the first direction.

### CROSS-REFERENCE TO RELATED APPLICATION

This application claims the priority benefit of Japan application serial no. 2024-047720, filed on Mar. 25, 2024. The entirety of the above-mentioned patent application is hereby incorporated by reference herein and made a part of this specification.

### BACKGROUND

### 1. Technical Field

The disclosure relates to a spatial light modulator (modulation element), etc.

### 2. Description of Disclosure

Three-dimensional (3D) displays can represent depth and thus can give viewers a high sense of realism. With development of services such as 3D movies and 3D televisions under consideration, 3D displays are expected to be next-generation displays. In particular, electronic holographic displays are attracting attention as a next-generation 3D display system as they can achieve natural stereoscopic vision that matches human sensibility by perfectly recreating the wavefront of object light.

For example as shown in FIG. 13, in electronic holography, an electronic device called a spatial light modulator (SLM) is used to recreate the wavefront of object light, and an electronic holographic image is recreated through the use of the diffraction of light by the SLM. Known modulation methods include an amplitude method that recreates the two-dimensional amplitude distribution of light and a phase method that recreates the phase distribution of light. The phase method has higher light use efficiency than the amplitude method and can suppress high-order diffracted light that interferes with the observation of the reproduced image, and therefore is considered to be a useful method for practical application. For example, JP 7379262B2 discloses a technique related to a spatial light modulator using liquid crystal, i.e. a liquid crystal on silicon-spatial light modulator (LCOS-SLM).

However, for practical application, electronic holography has a problem in that the range in which an image can be observed (viewing zone angle) is narrow. It is essential to drive the spatial light modulator at high resolution in order to widen the viewing zone angle.

FIG. 14 shows an example of a graph representing the relationship between pixel pitch (μm) and viewing zone angle (deg). The viewing zone angle depends on the diffraction angle of the SLM and depends on the pixel pitch which is the size of the pixels that constitute the SLM in a two-dimensional plane.

A viewing zone angle of 30° or more is required for practical application, and the pixel pitch needs to be 1 μm or less in order to achieve such a viewing zone angle. If the pixel pitch is 1 μm or less, however, it is difficult to drive pixels (individual pixels) independently due to electric field leakage between adjacent pixels when an electric field is applied.

JP 7379262B2 is an example of related art.

Thus, there is a demand to enable independent driving of pixels with a fine pixel pitch.

### SUMMARY

A first aspect of the disclosure is a spatial light modulator including: a first substrate; a second substrate facing the first substrate; and a liquid crystal layer located between the first substrate and the second substrate, wherein the first substrate has, on a substrate surface thereof, driving electrodes located on both sides of each of pixels arranged in a first direction among pixels arranged in a matrix and ground electrodes located between rows of driving electrodes arranged in the first direction.

A second aspect of the disclosure is a holographic 3D display device including the foregoing spatial light modulator, wherein the liquid crystal layer is driven by a horizontal electric field between the driving electrodes located on both sides of each of the pixels arranged in the first direction.

According to the disclosure, independent driving of pixels with a fine pixel pitch is enabled. Electric field leakage can be effectively suppressed by the driving electrodes located on both sides of each of the pixels arranged in the first direction and the ground electrodes located between the rows of the driving electrodes arranged in the first direction.

### BRIEF DESCRIPTION OF THE DRAWINGS

FIGS. 1A and 1B are diagrams showing an example of simulation results of liquid crystal alignment direction.

FIGS. 2A and 2B are explanatory diagrams of a continuous potential difference lateral electric field driving method.

FIG. 3 is a schematic plan view of a first substrate in a spatial light modulator.

FIGS. 4A and 4B are diagrams showing an example of a simulation structure and results of the continuous potential difference lateral electric field driving method.

FIGS. 5A and 5B are diagrams showing an example of a simulation structure and results of a simple lateral electric field driving method.

FIGS. 6A, 6B, and 6C are diagrams showing an example of experimental results in the case of using the continuous potential difference lateral electric field driving method.

FIGS. 7A, 7B, and 7C are diagrams showing an example of experimental results in the case of using a conventional vertical electric field driving method.

FIGS. 8A and 8B are diagrams showing an example of simulation results relating to independent driving of pixels.

FIGS. 9A and 9B are diagrams showing an example of a first simulation structure relating to the effect of suppressing electric field leakage by ground electrodes.

FIGS. 10A, 10B, and 10C are diagrams showing an example of simulation results of phase modulation distribution.

FIGS. 11A and 11B are diagrams showing an example of a second simulation structure relating to the effect of suppressing electric field leakage by ground electrodes.

FIGS. 12A, 12B, and 12C are diagrams showing an example of simulation results of phase modulation distribution.

FIG. 13 is an explanatory diagram of a spatial light modulator.

FIG. 14 shows an example of a graph representing the relationship between pixel pitch and viewing zone angle.

### DETAILED DESCRIPTION

An example of a mode for carrying out the disclosure will be described below with reference to the drawings.

The components described in this embodiment are merely examples, and are not intended to limit the scope of the disclosure.

### 1. Introduction

The above-described LCOS-SLM is a reflective optical device having a structure in which liquid crystal is interposed between a glass substrate having transparent common electrodes and driving electrodes that also serve as a reflector on a backplane with a voltage drive circuit formed on a silicon substrate. A thin polymer film called an alignment film is formed by application at the interface between the liquid crystal and the substrate. The liquid crystal molecules are bound so that their major axis direction will be one direction in a plane and also be parallel (horizontal) to the substrate by the alignment regulation force received from the alignment film. Accordingly, when no electric field is applied, the liquid crystal is aligned parallel to the substrate.

In this case, when linearly polarized light that vibrates parallel to the major axis direction of the liquid crystal molecules is incident, a high refractive index acts on the incident light. If an electric field is applied perpendicularly to the substrate, the liquid crystal molecules rotate due to dielectric constant anisotropy so that their major axes will approach parallel to the direction of the electric lines of force, as a result of which a low refractive index acts on the incident linearly polarized light. This creates a difference in phase between the light reflected from the pixel in the ON state and the light reflected from the pixel in the OFF state. Thus, the phase can be modulated two-dimensionally by application of an electric field at each pixel.

A holographic 3D display device in this embodiment includes a liquid crystal on silicon-spatial light modulator (LCOS-SLM) as a spatial light modulator.

The spatial light modulator is not limited to a phase modulation function, and may have a function of modulating the amplitude of incident light by the phase difference of orthogonally polarized light controlled by voltage using the refractive index anisotropy of liquid crystal (in this case, the spatial light modulator is required to have a π phase modulation capability for amplitude modulation, and an optical system such as a polarizer is needed). Thus, the spatial light modulator according to the disclosure may include a spatial light phase modulator and a spatial light amplitude modulator.

In order to solve the problem of electric field leakage mentioned above, a technique of dielectric shield wall structure has been proposed. In this technique, dielectric walls are arranged at the boundaries of pixels with a pixel pitch of 1 μm in a grid pattern, to divide the two-dimensionally arranged pixels. The walls suppress the electric field, reduces leakage, and enables independent driving of each pixel.

However, this method requires the placement of the dielectric walls at the pixel boundaries in a fine structure with a pixel pitch of 1 μm, which complicates the manufacturing process and increases the manufacturing cost. Another method and structure with a simplified manufacturing process are needed for achieving high resolution over a wider viewing range.

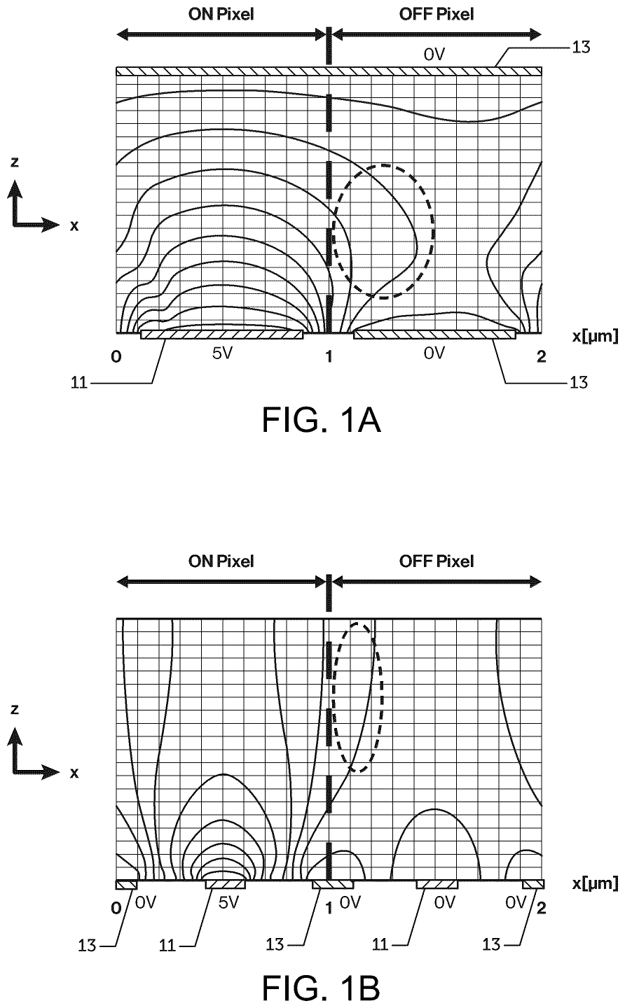

FIGS. 1A and 1B are diagrams showing an example of simulation results of liquid crystal alignment direction. In the drawings, the horizontal axis is an axis (x-axis) parallel to the substrate, and the vertical axis is an axis (z-axis) perpendicular to the substrate. A liquid crystal alignment simulator (LCD-Master, Shintech Co., Ltd.) based on the elastic continuum theory of liquid crystal was used for the calculation.

FIG. 1A is a diagram showing a conventional electric field application method (hereafter referred to as a vertical electric field driving method (vertical electric field driving)), and shows the equipotential line distribution and liquid crystal alignment distribution when pixels in the ON state (5 V) and pixels in the OFF state (0 V) are alternately arranged. The solid lines in the drawing represent the equipotential lines in increments of 0.5 V. Common electrodes 13 are indicated as “0 V” and driving electrodes 11 are indicated as “5 V”.

In the vertical electric field driving method, an electric field is applied perpendicularly to the substrate. With this method, however, the electric field spreads radially in a small area, so that electric field leakage to adjacent pixels increases. The spread (magnitude of spread) of electric field leakage is schematically indicated by the dashed line. It can be seen that the electric field leaks from the pixel in the ON state to the pixel in the OFF state.

FIG. 1B is a diagram showing an example of simulation results in the case of using a lateral electric field driving method (hereafter referred to as a simple lateral electric field driving method (simple lateral electric field driving)) used, for example, in direct-viewed liquid crystal displays (IPS-LCDs).

In this example, as shown in the area of the pixel in the ON state on the left side of the drawing, a driving electrode 11 is located at the center of the pixel, and an electric field is applied toward a common electrode 13 located at the pixel boundary. In this case, even if a voltage of the same magnitude as that of the vertical electric field driving method is applied, the spread of the electric field is smaller than that of the vertical electric field driving method. Hence, the use of the simple lateral electric field driving method makes it easier to suppress electric field leakage than when the vertical electric field driving method is used, even if a voltage of the same magnitude as that of the vertical electric field driving method is applied.

In fact, the spread of electric field leakage indicated by the dashed line in FIG. 1B is smaller than the spread of electric field leakage indicated by the dashed line in FIG. 1A.

Hence, in this embodiment, instead of driving the liquid crystal molecules by a vertical electric field by sandwiching the liquid crystal layer between two electrodes as in the conventional method, the liquid crystal molecules are driven by a horizontal electric field generated by an in-plane electrode pattern provided on one substrate to significantly reduce electric field leakage. The lateral electric field driving method has the advantage of not requiring dielectric walls.

### 2. Continuous Potential Difference Lateral Electric Field Driving Method

In the case of using the simple lateral electric field driving method, the initial alignment of the liquid crystal molecules is perpendicular to the substrate (perpendicular-to-substrate alignment). This is because, with in-plane rotation (rotating the liquid crystal molecules in a plane) used in IPS of LCOS, the polarization state changes and high light use efficiency cannot be achieved. The direction may be not exactly perpendicular but approximately perpendicular.

In the simple lateral electric field driving method, the driving electrode 11 is located at the center of the pixel, and an electric field is applied toward the common electrode 13 located at the pixel boundary. There is thus a problem in that it is difficult to obtain modulation at the center of the pixel because no change in the liquid crystal alignment on the driving electrode 11 can be obtained. In addition, since three electrodes are used, it is difficult to achieve high resolution due to limitations on fine formation of electrodes.

In view of this, in this embodiment, a lateral electric field driving method based on continuous potential difference by lateral electrodes (hereafter referred to as a continuous potential difference lateral electric field driving method (continuous potential difference lateral electric field driving)) is proposed.

In the continuous potential difference lateral electric field driving method, instead of using common electrodes 13 as in the simple lateral electric field driving method, driving electrodes 11 are located at the boundaries of each pixel (i.e. on both sides of each pixel). Then, for example, by continuously applying a voltage, an electric field is applied using the potential difference between driving electrodes 11. In other words, a voltage difference from an adjacent pixel is applied to a pixel electrode in the x-axis direction in the plane.

With such continuous potential difference lateral electric field driving, the resolution can be doubled compared to simple lateral electric field driving with the same electrode spacing.

In the case of using the continuous potential difference lateral electric field driving method, too, the initial alignment of the liquid crystal molecules may be perpendicular to the substrate.

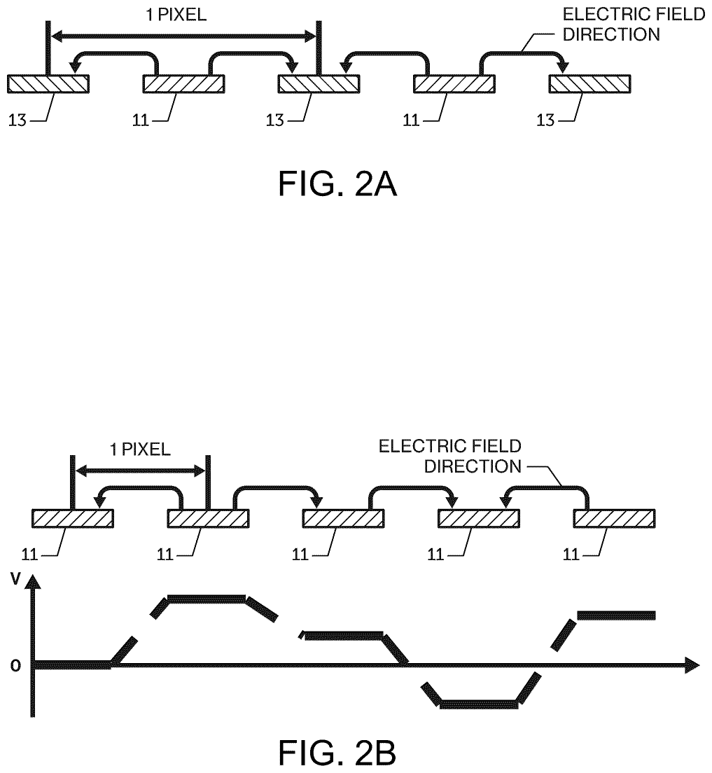

FIGS. 2A and 2B are explanatory diagrams of the continuous potential difference lateral electric field driving method.

FIG. 2B is a schematic diagram showing the concept of the continuous potential difference lateral electric field driving method proposed in this embodiment. FIG. 2A is a schematic diagram showing the concept of the simple lateral electric field driving method for comparison.

As shown in FIG. 2B, driving electrodes 11 are located on both sides of each of the pixels arranged on a first substrate, and a voltage is continuously applied to apply an electric field by using the potential difference between driving electrodes 11. Specifically, for a plurality of driving electrodes 11 arranged in the lateral (horizontal) direction (x-axis direction) on the xy plane, a potential difference is provided between a first driving electrode 11 and a second driving electrode 11 to generate an ON pixel and an OFF pixel. The first driving electrode 11 may be a single electrode or a plurality of consecutive electrodes. The second driving electrode 11 may be a single electrode or a plurality of consecutive electrodes.

This method has an effective structure for achieving high resolution with fewer electrodes and a simpler pixel structure than the simple lateral electric field driving method.

In this case, with regard to the structure of the pixels and electrodes of the spatial light modulator in this embodiment, the spatial light modulator may include: a first substrate; a second substrate facing the first substrate; and a liquid crystal layer located between the first substrate and the second substrate, wherein the first substrate has, on its substrate surface, driving electrodes located on both sides of each of the pixels arranged in a first direction among the pixels arranged in a two-dimensional matrix (hereafter the same). The first direction may be parallel to the substrate. The direction may be not exactly parallel but approximately parallel.

Based on this structure, a holographic 3D display device using a spatial light modulator and reference light may be provided. The holographic 3D display device may include the foregoing spatial light modulator, wherein the liquid crystal layer (liquid crystal molecules) is driven by a horizontal electric field between the driving electrodes located on both sides of each of the pixels arranged in the first direction.

As a method of driving the liquid crystal layer by the horizontal electric field between the driving electrodes located on both sides of each of the pixels arranged in the first direction, for example, the liquid crystal layer may be driven by the potential difference between the driving electrodes located on both sides of each of the pixels arranged in the first direction.

In an initial alignment state in which the liquid crystal molecules in the liquid crystal layer are aligned perpendicularly to the substrate, the alignment of the liquid crystal molecules may be changed by the horizontal electric field. In other words, after perpendicular (vertical) alignment control (perpendicular alignment processing) is performed to align the liquid crystal molecules perpendicularly to the substrate as the initial alignment, the alignment of the liquid crystal molecules may be changed by the horizontal electric field.

### 3. Ground Electrode

In the case where the driving electrodes 11 are arranged on the first substrate as shown in FIG. 2B, there is a possibility that electric field leakage occurs in the y-axis direction in the xy plane.

In view of this, in this embodiment, ground electrodes 15 may be provided between the electrode rows, in addition to the above-described structure.

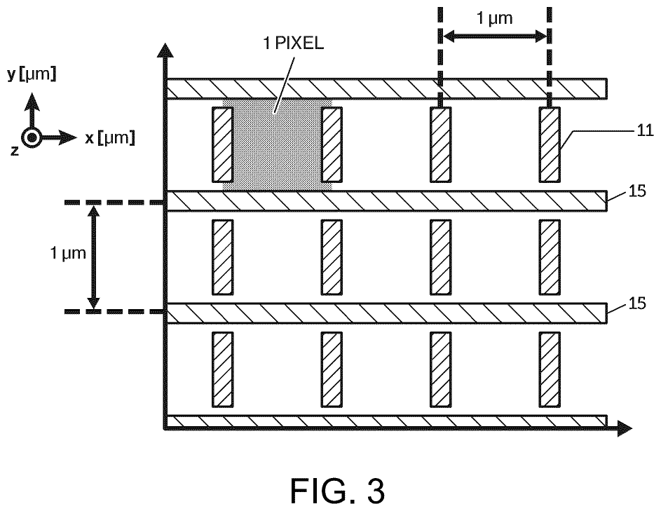

FIG. 3 is a schematic plan view of the first substrate in this case. The horizontal axis is the x-axis (axis parallel to the substrate, units: μm), and the vertical axis is the y-axis (axis orthogonal to the x-axis in the plane, units: μm) which is orthogonal to the x-axis and z-axis. The spacing between the driving electrodes 11 in the x-axis direction is 1 μm, and the spacing between the ground electrodes 15 in the y-axis direction is 1 μm.

As mentioned above, pixels are arranged in a matrix on the substrate surface of the first substrate, and driving electrodes 11 are located on both sides of each of the pixels arranged in the x-axis direction (direction parallel to the substrate, first direction).

Moreover, ground electrodes 15 are located between the electrode rows of the pixels arranged in the x-axis direction (i.e. between the rows of the electrodes arranged in the x-axis direction). In other words, ground electrodes 15 are located between driving electrodes 11 in the y-axis direction. These ground electrodes 15 suppress electric field leakage in the y-axis direction.

In this case, with regard to the structure of the pixels and electrodes of the spatial light modulator in this embodiment, the spatial light modulator may include: a first substrate; a second substrate facing the first substrate; and a liquid crystal layer located between the first substrate and the second substrate, wherein the first substrate has, on its substrate surface, driving electrodes located on both sides of each of the pixels arranged in a first direction among the pixels arranged in a matrix and ground electrodes located between the rows of the driving electrodes arranged in the first direction.

### 4. Verification of Continuous Potential Difference Lateral Electric Field Driving Method

In a liquid crystal on silicon-spatial light modulator that uses phase modulation, the required phase modulation amount is 2π. Here, when using a reflective type, the incident light travels back and forth through the liquid crystal layer, so that it is sufficient to obtain phase modulation of π each way.

Since a lateral electric field does not spread much, it is difficult to obtain perfect horizontal alignment in a plane. Therefore, a liquid crystal material with large refractive index anisotropy and dielectric constant anisotropy is used. As a result of examination with such imperfect liquid crystal alignment taken into consideration, it was found that the thickness of the liquid crystal layer required for sufficient phase modulation is 2 μm.

With a liquid crystal layer thickness of 2 μm, simulation was performed for each of the simple lateral electric field driving method and the continuous potential difference lateral electric field driving method, and comparative analysis was conducted using the phase modulation distribution and the potential alignment distribution. The simulation conditions were as follows:
Liquid crystal material: birefringence 0.5, dielectric constant anisotropy 19.5
Initial alignment of liquid crystal molecules: perpendicular alignment
Anchoring strength: 10⁻⁶ [J/m²]
Pixel pitch: 1 μm.

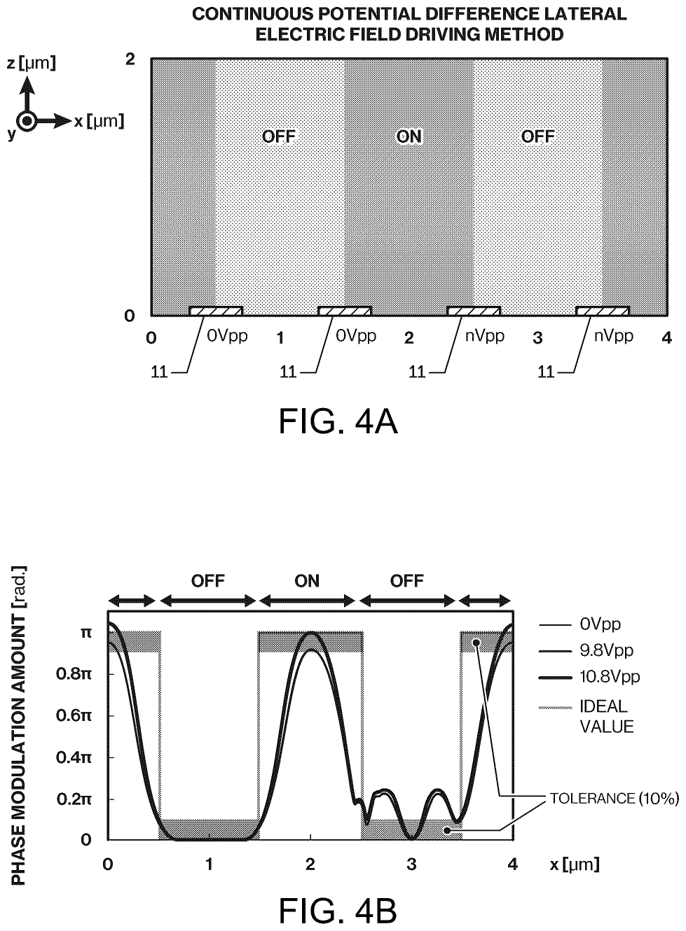

FIGS. 4A and 4B are diagrams showing an example of the simulation structure and results of the continuous potential difference lateral electric field driving method.

In order to determine independent driving of each pixel, pixels driven so that the phase modulation will be 0 (OFF pixels, designated as “OFF” in the drawings) and pixels driven so that the phase modulation will be π (ON pixels, designated as “ON” in the drawings) are alternately arranged. To create this state, the driving electrodes 11 that form each OFF pixel need to be at the same potential, and the driving electrodes 11 that form each ON pixel need to be at different potentials. As an example, the width of each driving electrode 11 was set to 0.2 μm and the width between the electrodes was set to 0.8 μm, and tests were conducted on whether the required phase modulation amount could be obtained for each pixel and whether each pixel could be driven independently in this state.

A liquid crystal alignment simulator (LCD-Master, Shintech Co., Ltd.) based on the elastic continuum theory of liquid crystal was used for the calculation.

FIG. 4A shows a structure in which ON pixels and OFF pixels are alternately driven, with the horizontal axis being the x-axis (units: μm) and the vertical axis being the z-axis (units: μm). FIG. 4B shows the phase modulation amount for each pixel, with the horizontal axis being the x-axis (units: μm) and the vertical axis being the phase modulation amount (units: rad). The results in the case where the potential difference of the ON pixel (corresponding to potential n Vpp in FIG. 4A) was set to 0 Vpp, 9.8 Vpp, and 10.8 Vpp (where Vpp is the difference between the maximum and minimum AC voltages) are shown, with each phase modulation amount being indicated by a line with a different thickness. An ideal value of the phase modulation amount is indicated by a dashed line, and the tolerance of the phase modulation amount is indicated by a rectangular area.

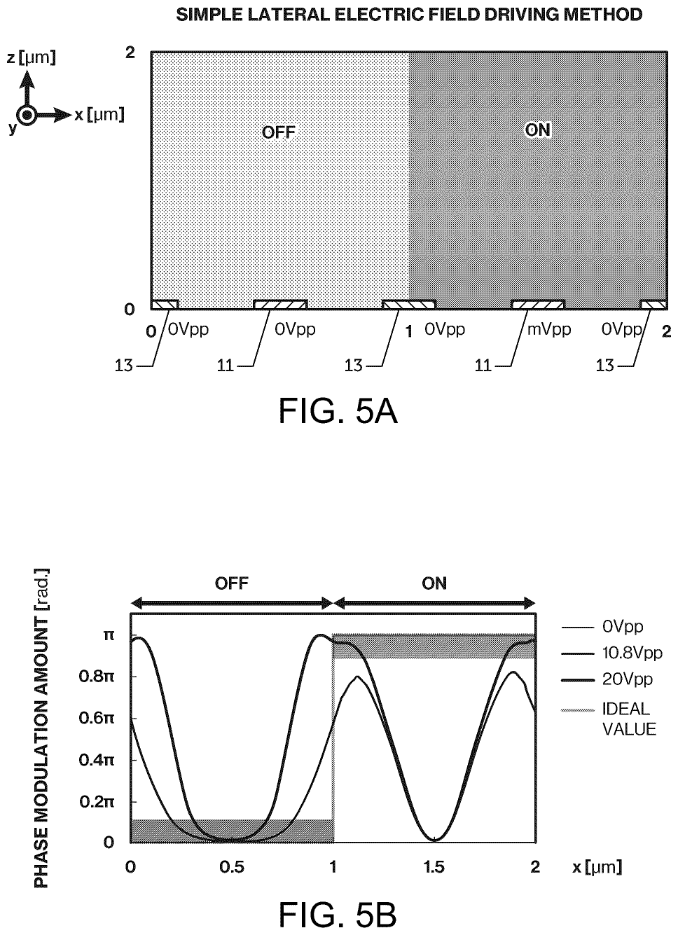

For comparison, FIGS. 5A and 5B show an example of the simulation structure and results of the simple lateral electric field driving method. The drawings can be read in the same way as FIGS. 4A and 4B. FIGS. 5A and 5B show the results in the case where the potential difference of the ON pixel (corresponding to potential m Vpp in FIG. 5A) was set to 0 Vpp, 10.8 Vpp, and 20 Vpp.

As can be seen from the results in FIGS. 4A and 4B, in the continuous potential difference lateral electric field driving method in this embodiment, the phase modulation amount falls within the tolerance, and a sufficient phase modulation amount is ensured. In other words, by using the continuous potential difference lateral electric field driving method with a pixel pitch of 1 μm, a sufficient phase modulation amount of π is ensured and pixels can be driven independently.

In the simple lateral electric field driving method, there is no modulation at the center of the pixel, which may be disadvantageous in terms of further narrowing the pixel pitch. In this respect, the continuous potential difference lateral electric field driving method is more advantageous.

In order to observe the foregoing simulation results, an experiment was conducted in which a liquid crystal cell was produced and observed with a polarizing microscope. In addition, an experiment was conducted in which the luminance value distribution was calculated from the polarizing microscope image to determine the modulation degree (2=500 nm) in driving. The experimental results for the conventional vertical electric field driving method and the continuous potential difference lateral electric field driving method in this embodiment are shown.

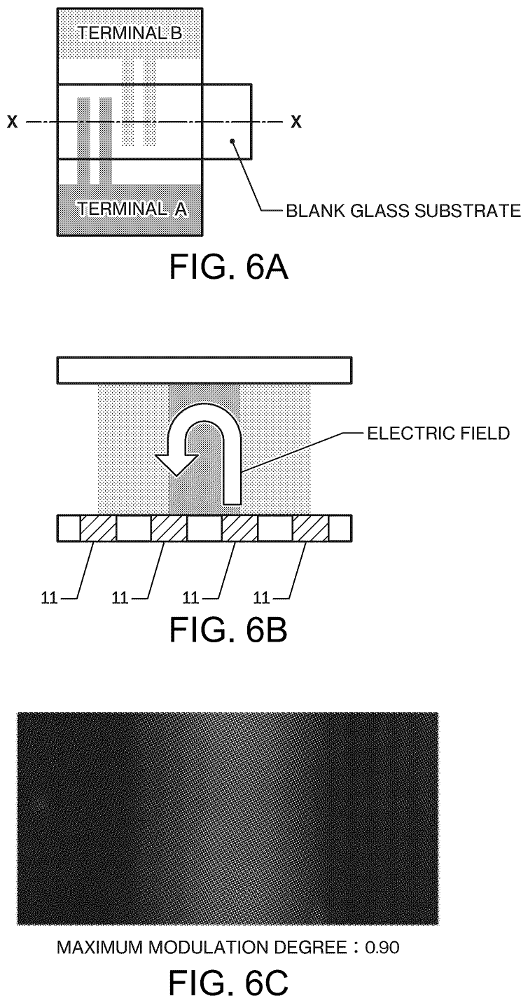

FIGS. 6A, 6B, and 6C are diagrams showing an example of the experimental results in the case of using the continuous potential difference lateral electric field driving method in this embodiment. FIG. 6A shows the structure of the produced liquid crystal cell, FIG. 6B shows an X-X cross-section in FIG. 6A, and FIG. 6C shows the light modulation observation results. A glass substrate with an indium tin oxide (ITO) electrode pattern was used as the lower substrate, and a blank glass substrate was used as the upper substrate. The produced liquid crystal cell was observed under crossed Nicols using a polarizing microscope. The ON pixel part appears bright, and the OFF pixel part appears dark.

The maximum modulation degree was calculated using the following formula (1):

$$Maximum modulation degree = ( {P}_{m ax} - {P}_{m i n} ) / ( {P}_{m ax} + {P}_{m i n} ) \qquad ( 1 )$$

where Pₘₐₓ and Pₘᵢₙ are the maximum and minimum luminance values in the modulation area, respectively.

As can be seen from the observation results in FIG. 6C, the ON pixel part appears bright, and the OFF pixel part appears dark. The maximum modulation degree calculated using formula (1) was 0.90.

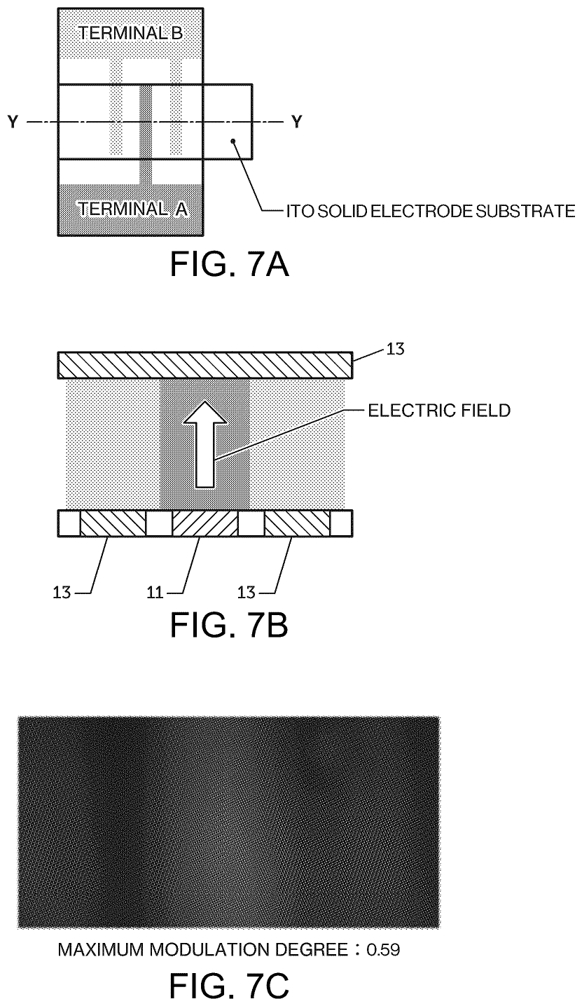

FIGS. 7A, 7B, and 7C are diagrams showing an example of the experimental results in the case of using the conventional vertical electric field driving method. FIG. 7A shows the structure of the produced liquid crystal cell, FIG. 7B shows a Y-Y cross-section in FIG. 7A, and FIG. 7C shows the light modulation observation results. The drawings can be read in the same way as FIGS. 6A, 6B, and 6C.

In this case, the maximum modulation degree calculated using formula (1) was 0.59.

In the continuous potential difference lateral electric field driving method in this embodiment, a larger value (0.90) was obtained compared to the maximum modulation degree of 0.59 in the conventional vertical electric field driving method, demonstrating the superiority of the continuous potential difference lateral electric field driving method in this embodiment.

From these results, independent driving of pixels was observed with a pixel pitch of 1 μm in the continuous potential difference lateral electric field driving method in this embodiment.

Moreover, in order to determine the effectiveness of the continuous potential difference lateral electric field driving method in this embodiment, simulation analysis was conducted with a pixel pitch of less than 1 μm. The simulation conditions were as follows:
Liquid crystal material: birefringence 0.5, dielectric constant anisotropy 19.5
Initial alignment of liquid crystal molecules: perpendicular alignment
Anchoring strength: 10⁻⁶ [J/m²]
Pixel pitch: 0.8 μm.

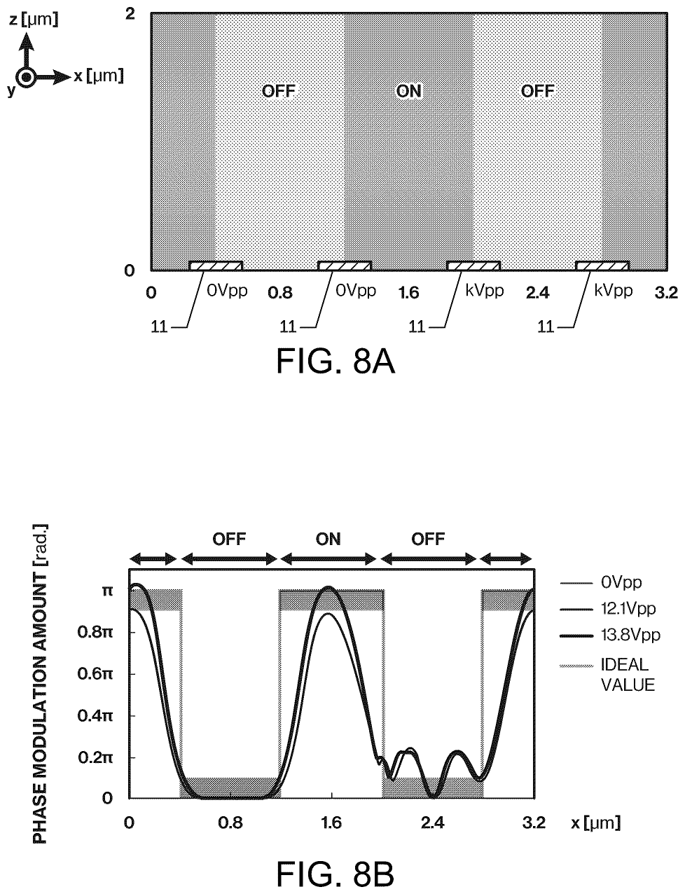

FIGS. 8A and 8B are diagrams showing an example of the simulation results in this case. The drawings can be read in the same way as FIGS. 4A and 4B. FIGS. 8A and 8B show the results in the case where the potential difference of the ON pixel (corresponding to k Vpp in FIG. 8A) was set to 0 Vpp, 12.1 Vpp, and 13.8 Vpp.

As can be seen from the results, by using the continuous potential difference lateral electric field driving method with a pixel pitch of less than 1 μm, a sufficient phase modulation amount of π is ensured and pixels can be driven independently.

The above results demonstrate that the continuous potential difference lateral electric field driving method in this embodiment is useful for holographic 3D display devices that require a pixel structure with a pixel pitch of 1 μm or less.

### 5. Verification of Effect of Suppressing Electric Field Leakage (Electric Field Shielding Effect) by Ground Electrode

In the continuous potential difference lateral electric field driving method in this embodiment, electric field leakage can affect the driving of pixels in adjacent rows, which may make it difficult to independently drive all pixels arranged in a two-dimensional plane. A structure that suppresses electric field leakage between rows is thus needed. Hence, ground electrodes 15 can be provided between rows.

In order to determine the effectiveness of this structure, simulation was performed to verify whether electric field leakage between rows is suppressed by ground electrodes 15 and all pixels in a two-dimensional plane are driven independently.

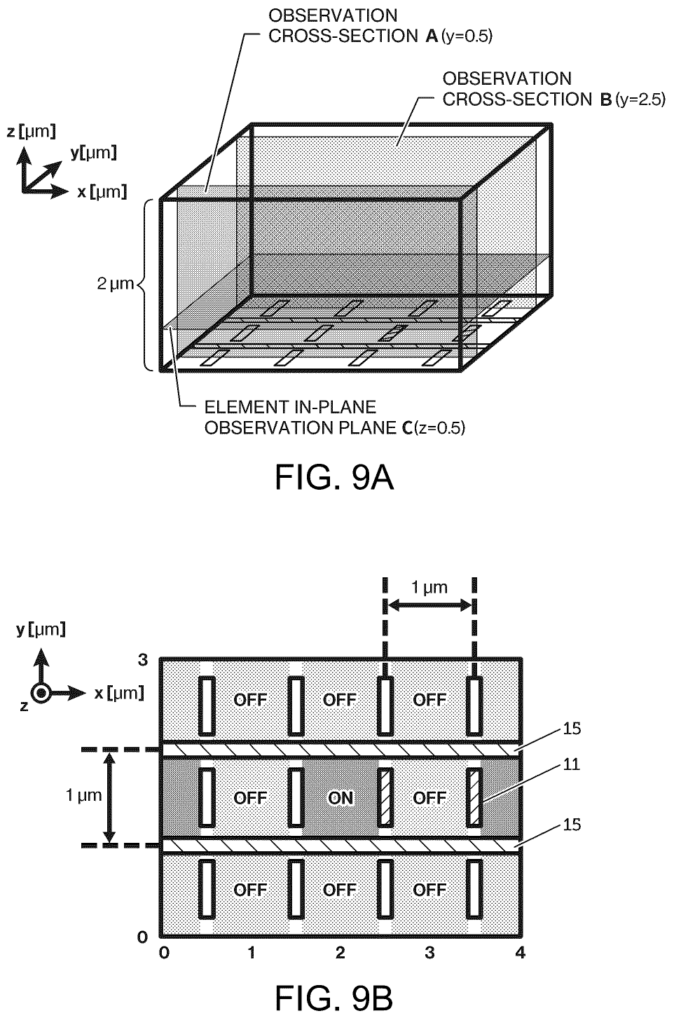

FIGS. 9A and 9B are diagrams showing an example of a first simulation structure relating to the effect of suppressing electric field leakage by ground electrodes. FIG. 9A shows the structure of the liquid crystal element, and FIG. 9B is a schematic plan view of the first substrate in the liquid crystal element corresponding to FIG. 3.

As shown in the drawings, the lateral electrodes in the row between y=1 and y=2 are driven so that ON and OFF pixels will alternate. The lateral electrodes in the rows between y=0 and y=1 and between y=2 and y=3 are not driven and all pixels are OFF pixels.

As an example, 10.8 Vpp, which ensures a sufficient phase modulation amount, was applied. The phase modulation distribution was then analyzed for three cross-sections: observation cross-section A at y=0.5, observation cross-section B at y=2.5, and element in-plane observation plane C at z=0.5.

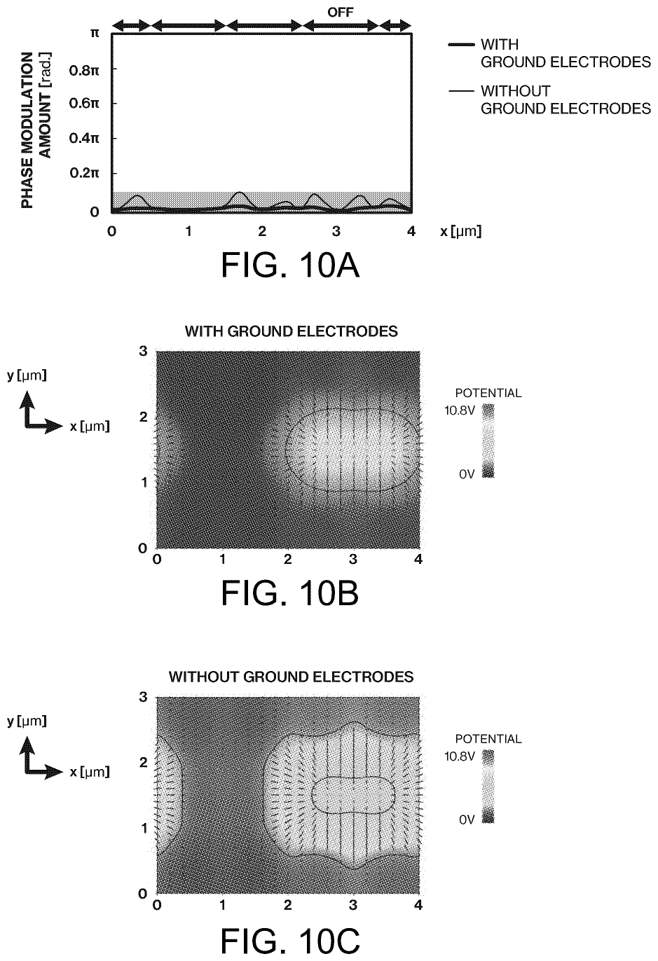

FIGS. 10A, 10B, and 10C are diagrams showing an example of the simulation results of the phase modulation distribution in this case. FIG. 10A shows the results for observation cross-section A, and FIGS. 10B and 10C show the results for element in-plane observation plane C. Since the results for observation cross-section B were the same as those for observation cross-section A, their illustration is omitted.

FIG. 10A shows a graph for each of the cases with and without the ground electrodes 15, with the horizontal axis being the x-axis (units: μm) and the vertical axis being the phase modulation amount (units: rad). FIG. 10B shows the distribution of the phase modulation amount in the xy plane in the case with the ground electrodes 15. FIG. 10C shows the distribution of the phase modulation amount in the xy plane in the case without the ground electrodes 15.

As can be seen from these results, in driving with a pixel pitch of 1 μm, the phase modulation amount of the surrounding OFF pixels was suppressed to approximately 0, demonstrating that electric field leakage is shielded by the ground electrodes 15 and two-dimensionally arranged pixels can be driven independently.

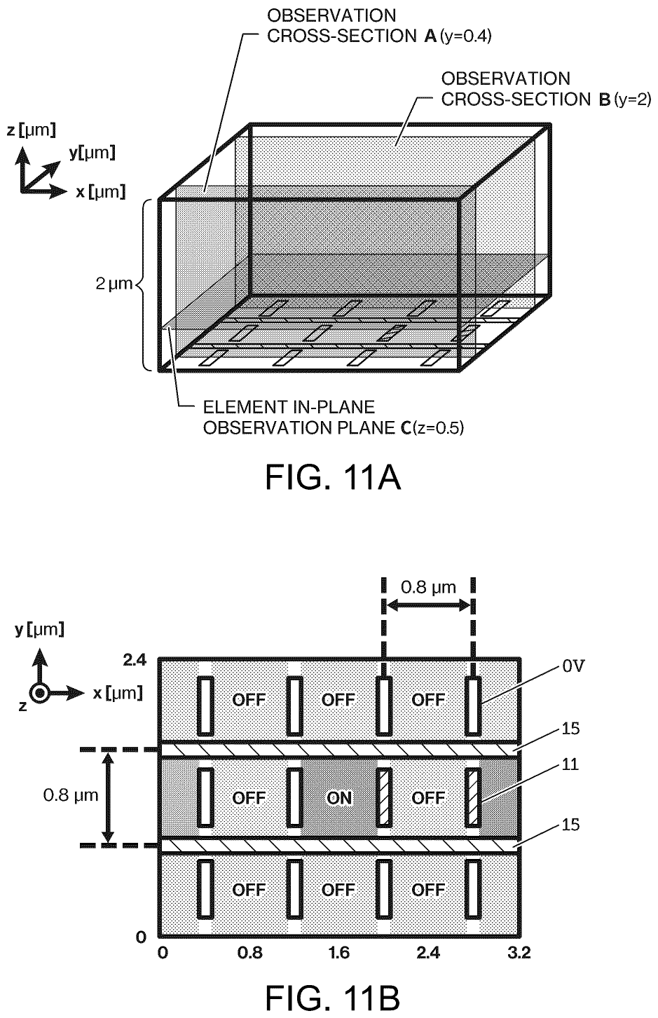

FIGS. 11A and 11B are diagrams showing an example of a second simulation structure relating to the effect of suppressing electric field leakage by ground electrodes.

FIG. 11A shows the structure of the liquid crystal element, and FIG. 11B is a schematic plan view of the first substrate in the liquid crystal element corresponding to FIG. 3.

The drawings can be read in the same way as FIGS. 9A and 9B. Here, the pixel pitch was set to 0.8 μm, which is less than 1 μm, and 13.8 Vpp, which ensures a sufficient phase modulation amount, was applied as an example.

The phase modulation distribution was then analyzed for three cross-sections: observation cross-section A at y=0.4, observation cross-section B at y=2, and element in-plane observation plane C at z=0.5.

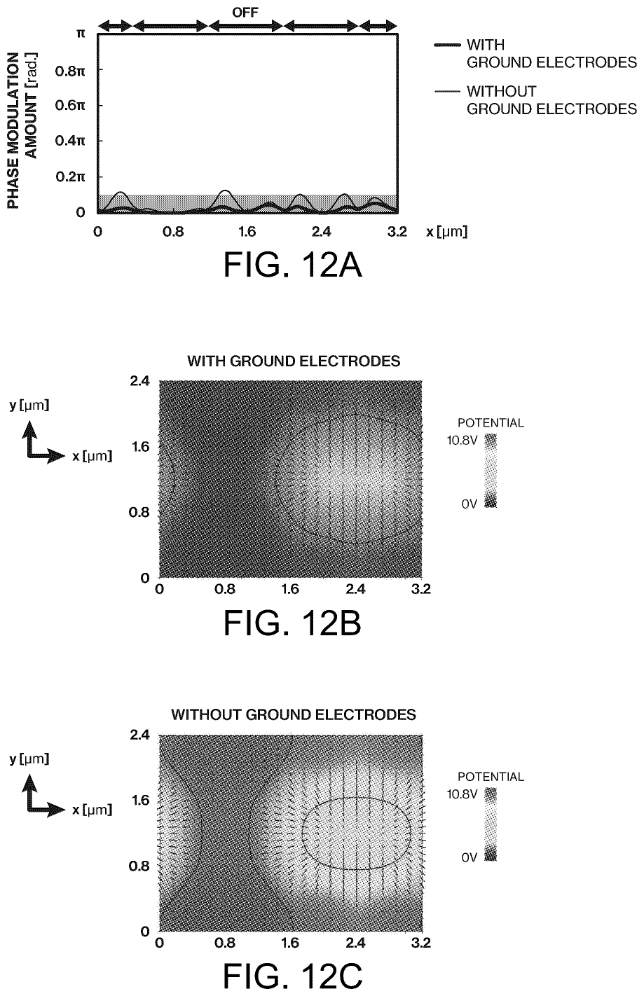

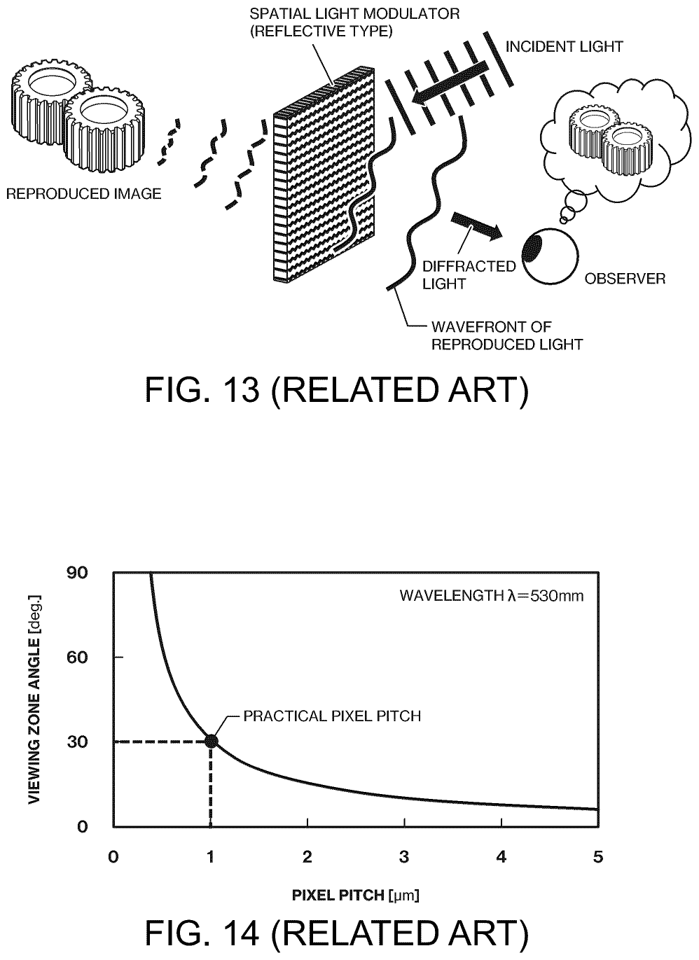

FIGS. 12A, 12B, and 12C are diagrams showing an example of the simulation results of the phase modulation distribution in this case. FIG. 12A shows the results for observation cross-section A, and FIGS. 12B and 12C show the results for element in-plane observation plane C. The drawings can be read in the same way as FIGS. 10A, 10B, and 10C. Since the results for observation cross-section B were the same as those for observation cross-section A, their illustration is omitted.

As can be seen from these results, in driving with a pixel pitch of 0.8 μm which is less than 1 μm, too, the phase modulation amount of the surrounding OFF pixels was suppressed to approximately 0, demonstrating that electric field leakage is shielded by the ground electrodes 15 and two-dimensionally arranged pixels can be driven independently.

### 6. Effects of Embodiment

The spatial light modulator in this embodiment is a spatial light modulator including: a first substrate; a second substrate facing the first substrate; and a liquid crystal layer located between the first substrate and the second substrate, wherein the first substrate has, on a substrate surface thereof, driving electrodes located on both sides of each of pixels arranged in a first direction among pixels arranged in a matrix and ground electrodes located between rows of driving electrodes arranged in the first direction.

A holographic 3D display device (holographic 3D display device using a spatial light modulator and reference light) may be provided that includes the foregoing spatial light modulator, wherein the liquid crystal layer is driven by a horizontal electric field between the driving electrodes located on both sides of each of the pixels arranged in the first direction.

Such structure enables independent driving of pixels with a fine pixel pitch. Electric field leakage can be effectively suppressed by the driving electrodes located on both sides of each of the pixels arranged in the first direction and the ground electrodes located between the rows of the driving electrodes arranged in the first direction.

As a method of driving the liquid crystal layer by the horizontal electric field between the driving electrodes located on both sides of each of the pixels arranged in the first direction, for example, the liquid crystal layer may be driven by the potential difference between the driving electrodes located on both sides of each of the pixels arranged in the first direction.

The simple lateral electric field driving method in which a driving electrode is located at the center of the pixel and an electric field is applied toward a common electrode located at the pixel boundary has a problem in that it is impossible to obtain modulation at the center of the pixel because no change in the liquid crystal alignment on the driving electrode can be obtained.

This problem can be solved by driving the liquid crystal layer by a horizontal electric field between driving electrodes located on both sides of each of the pixels arranged in the first direction (for example, driving the liquid crystal layer by a potential difference between driving electrodes located on both sides of each of the pixels arranged in the first direction) as in this embodiment. In addition, the number of electrodes can be reduced compared to the simple lateral electric field driving method, with it being possible to achieve a narrower pixel pitch (higher resolution).

In an initial alignment state in which the liquid crystal molecules in the liquid crystal layer are aligned perpendicularly to the substrate, the alignment of the liquid crystal molecules may be changed by the horizontal electric field.

This allows the alignment of the liquid crystal molecules to be changed in the horizontal direction (tilting the liquid crystal molecules in the horizontal direction) by the horizontal electric field, thus achieving high light use efficiency.

In the holographic 3D display device in this embodiment, the pixel pitch of the pixels in the first direction may be 1 μm or less, and the viewing zone angle may be 30° or more.

A practical holographic 3D display device can thus be provided.

What is claimed is:

1. A spatial light modulator comprising:
a first substrate;
a second substrate facing the first substrate; and
a liquid crystal layer located between the first substrate and the second substrate,
wherein the first substrate has, on a substrate surface thereof, driving electrodes located on both sides of each of pixels arranged in a first direction among pixels arranged in a matrix and ground electrodes located between rows of driving electrodes arranged in the first direction.

2. A holographic 3D display device comprising
the spatial light modulator according to claim 1,
wherein the liquid crystal layer is driven by a horizontal electric field between the driving electrodes located on both sides of each of the pixels arranged in the first direction.

3. The holographic 3D display device according to claim 2, wherein the liquid crystal layer is driven by a potential difference between the driving electrodes located on both sides of each of the pixels arranged in the first direction.

4. The holographic 3D display device according to claim 2, wherein in an initial alignment state in which liquid crystal molecules in the liquid crystal layer are aligned perpendicularly to the substrate, alignment of the liquid crystal molecules is changed by the horizontal electric field.

5. The holographic 3D display device according to claim 2, wherein a pixel pitch of the pixels in the first direction is 1 μm or less.

6. The holographic 3D display device according to claim 2, having a viewing zone angle of 30° or more.
